(19) United States
(12) Patent Application Publication
(10) Pub. No.: US 2009/0192278 A1
(43) Pub. Date: Jul. 30, 2009

(54) Alkene polymerization using beta-ketoiminato metal complexes

(75) Inventors: Geoffrey W Coates, Ithaca, NY (US); Yuguo Min, Chelmsfort, MA (US)

Correspondence Address: BACON & THOMAS, PLLC, 625 SLATERS LANE, FOURTH FLOOR, ALEXANDRIA, VA, 22314-1176, US

(73) Assignee: Cornell Research Foundation Inc., Ithaca, NY (US)

(21) Appl. No.: 11/629,985

(22) PCT Filed: Aug. 8, 2005
(86) PCT No.: PCT/US05/27927

§ 371 Date: Dec. 19, 2006

Related U.S. Application Data
(60) Provisional application No. 60/602,320, filed on Aug. 18, 2004.

(51) Int. Cl. C08F 4/76; C07F 7/28; C07F 7/00

(52) U.S. Cl. 526/172; 556/56; 528/396

(57) ABSTRACT

Group (IV) and (X) metal complexes with ketoiminate ligands are prepared by deprotonation of a ketoimine ligand followed by reaction with the appropriate metal halide. In preferred cases, the compounds are titanium (IV), zirconium (IV) and hafnium (IV), preferred cases, the compounds are titanium (IV), zirconium (IV) and hafnium (IV) complexes with (arylimino-alkyl)-spiro[4,5]decan-6-one ligands. The compounds are useful as catalysts for polymerizing ethylene, C₃-C₁₀-alpha olefins and C₄-C₁₀ cyclic alkenes and for copolymerizing ethylene with comonomers.

### CROSS-REFERENCE TO RELATED APPLICATIONS

This application claims the benefit of U.S. Provisional Application No. 60/602,320, filed Aug. 18, 2004, the whole of which is incorporated herein by reference.

The invention was made at least in part with United States Government support under National Science Foundation related grant CCMR (Cornell Center for Materials Research) Grant Number DMR 0079992. The United States Government has certain rights in the invention.

### TECHNICAL FIELD

This invention is directed to group (IV) and group (X) metal complexes with beta-ketoiminato ligands and to the use of these complexes as catalysts for polymerization of ethylene, C₃-C₁₀-alpha olefins, C₄-C₁₀ cyclic alkenes and for the copolymerization of ethylene and comonomers.

### BACKGROUND OF THE INVENTION

Group (IV) and group (X) metal complex catalysts with beta-ketoiminato ligands for use for polymerizing ethylene and alpha olefins are known. See Kim, J., et al, Journal of Organometallic Chemistry 620, 1-7 (2001); Li, X.-F., et al, Organometallics 23, 1223-1230 (2004); Zhang, D., et al, Organometallics 23, 3270-3275 (2004).

These efforts have focused on complexes with beta-ketoiminato ligands, where carbon alpha to the carbonyl carbon is planar (sp²-hybridized) or methyl or trifluoromethyl.

A new family of ligands is important to enrich the pool for catalyst discovery.

### SUMMARY OF THE INVENTION

It has been discovered herein that a new family of ligands is available where a carbon alpha to a carbonyl carbon is a tetrahedral carbon, that is a carbon which has four bonds extending in different directions.

In an embodiment of the invention, denoted the first embodiment, there is provided a compound having the structure:

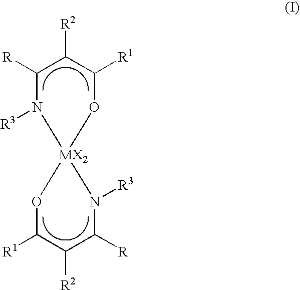

where M is selected from the group consisting of titanium, zirconium and hafnium; where X is selected from the group consisting of halogens, C₁-C₂₀ hydrocarbons, C₁-C₂₀ alkoxides and C₁-C₂₀ amides; where R is selected from the group consisting of hydrogen, C₁-C₂₀ hydrocarbons, C₁-C₂₀ fluorocarbons (includes, for example, fluoroalkyls and fluoroaryls including those with both H and F substituents) and C₃-C₂₀ heterocycles; where R¹ is selected from the group consisting of C₂-C₂₀ hydrocarbons bound by a tetrahedral carbon atom, i.e., where carbon alpha to carbonyl carbon, i.e., the carbon bonded to oxygen of ketoimine moiety is a tetrahedral carbon; R² is selected from the group consisting of hydrogen, C₁-C₂₀ hydrocarbons, C₁-C₂₀ fluorocarbons (includes, for example, fluoroalkyls and fluoroaryls including those with both H and F substituents) and C₃-C₂₀ heterocycles; R³ is selected from the group consisting of C₁-C₂₀ hydrocarbons, C₁-C₂₀ fluorocarbons (includes, for example, fluoroalkyls and fluoroaryls including those with both H and F substituents) and C₃-C₂₀ heterocycles; where two or more of R, R¹, R² and R³ can be bonded together to form a ring; or having the structure:

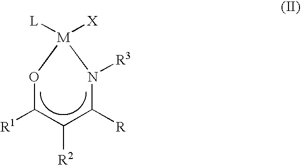

where M is selected from the group consisting of nickel and palladium, L is a neutral two electron donor i.e., an uncharged group which fulfills the function of filling the coordination valance of M, e.g., an ether, phosphine or nitrile group), X, R, R¹, R² and R³ are defined as above and where two or more of R, R¹, R² and R³ can be bonded together to form a ring.

In preferred cases, R¹ and R² are bonded together thereby forming (arylimino-alkyl)-spiro[4,5]decan-6-one ligand (two for (I) and one for (II)), i.e., to contain spiro[4,5]decane-6-onato moiety. In this case, the compounds have the structure:

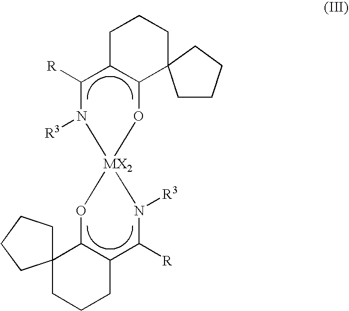

where M is selected from the group consisting of titanium, zirconium, and hafnium, and R and R³ are defined as above and R and R³ can be bonded together to form a ring or have the structure:

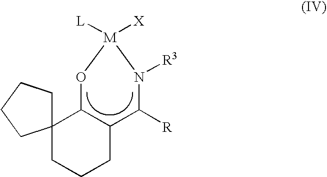

where M is selected from the group consisting of nickel and palladium and L, R and R³ are defined as above and R and R³ can be bonded together to form a ring.

Preferably X is Cl, R is H or CF₃ and R³ is phenyl or fluorinated phenyl and even more preferably the compound contains at least one fluorine atom.

The compounds (I), (II), (III) and (IV) are useful as catalysts for polymerization of ethylene, C₃-C₁₀ alpha olefins, and C₄-C₁₀ cyclic alkenes and for copolymerizing ethylene and comonomer selected from the group consisting of C₃-C₁₀ alpha olefins, styrene, C₃-C₁₀ dienes, C₃-C₁₀ alkenyl halides and C₄-C₁₀ cyclic alkenes.

In another embodiment of the invention, denoted the second embodiment, ethylene is polymerized in the presence of a catalytically effective amount of activated compound (I), e.g., activated compound (III), to produce polyethylene of Mₙ in the range of 1,000 to 3,000,000 and polydispersities (PDI) in the range of 1 to 3.

In still another embodiment of the invention, denoted the third embodiment, C₃-C₁₀ alpha olefin is polymerized in the presence of a catalytically effective amount of activated compound (I), e.g., activated compound (III), to produce poly(C₃-C₁₀ alpha olefin) of Mₙ ranging from 1,000 to 3,000,000 and PDI ranging from 1 to 3.

In still another embodiment of the invention, denoted the fourth embodiment, C₄-C₁₀ cyclic alkene is polymerized in the presence of a catalytically effective amount of activated compound (I), e.g., activated compound (III), to produce poly(C₄-C₁₀ cyclic alkene) of M, ranging from 1,000 to 3,000,000 and PDI ranging from 1 to 3.

In still another embodiment of the invention, denoted the fifth embodiment, ethylene and comonomer in a mole ratio of ethylene to comonomer ranging from 1:99 to 99:1 are copolymerized in the presence of a catalytically effective amount of activated compound (I), e.g., activated compound (III), to produce copolymer of ethylene and said comonomer of M, ranging from 1,000 to 3,000,000.

Where M is Ti and X is Cl, the polymerizations/copolymerizations are advantageously carried out with the activation being effected by an activating effective amount of methylaluminoxane such that [Al]:[Ti] mole ratio ranges from 100 to 200:1; e.g., 125 to 175:1.

Where M is Zr and X is Cl, the polymerizations/copolymerizations are carried out with the activation being effected by an activating effective amount of methylaluminoxane of compounds of the first embodiment herein such that [Al]:[Zr] mole ratio ranges from 100 to 200:1; e.g., 150:1.

Where M is Hf and X is Cl, the polymerization/copolymerization are advantageously carried out with the activation being effected by an activating effective amount of methylaluminoxane such that [Al]:[Hf] mole ratio ranges from 100 to 200:1; e.g., 150:1.

The said polymerizations/copolymerizations can also be carried out in the presence of an activating effective amount of trialkylaluminum/fluorinated borate salts, such as i-Bu₃Al/Ph₃C⁺B(C₆F₅)₄⁻ such that [Al]:[B]:[M] mole ratio ranges from 10 to 100:2:1; e.g., 40:2:1.

The molecular weights and polydispersities (PDI) are determined by high temperature gel-permeation chromatography using monodisperse polyethylene standards.

### DETAILED DESCRIPTION

We turn now to the first embodiment of the invention.

We turn now to synthesis of compounds of the structure (I).

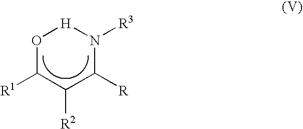

(V) where R, R¹, R² and R³ are defined as for structure (I), is deprotonated in solvent, e.g., at −78° C. with 1 equivalent of butyllithium followed by reaction with MX₄. The lithium of BuLi replaces the H in (V) and 2Lig-Li+MX₄ gives (Lig)₂ MX₂+2 LiX.

We turn now to synthesis of the compounds of the structure (III). Spiroketone (VI)

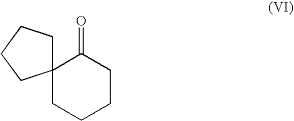

is obtained, for example, through a pinacol rearrangement from [1,1′-bicyclopentyl]-1,1′-diol. This synthesis is described in Kita, Y., et al., Tetrahedron Lett 38, 8315-8318 (1997) and Kita, Y., Tetrahedron 54, 14689-14704 (1998). Where R³ is C₁-C₂₀ hydrocarbon or C₁-C₂₀ fluorocarbon, coupling of R³N═C(R)Cl with spiroketone generates the corresponding ligand whereupon deprotonation followed by reaction with MX₄ as described above gives compound (III). The compound R³N═C(R)Cl is prepared by reacting R³NH₂ and RC(O)OH in CCl₄ with Ph₃P and Et₃N. Where R is H, the spiroketone (VI) is first formylated using ethyl formate to generate aldehyde which is coupled with R³NH₂ under neat conditions in the presence of p-toluenesulfonic acid and phosphorus pentoxide to generate ligand whereupon deprotonation followed by reaction with MX₄ as described above gives compound (III).

We turn now to synthesis of the compounds of the structure (II).

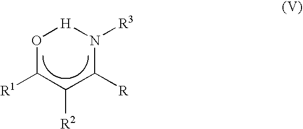

(V) is deprotonated in solvent, e.g., at −78° C. with one equivalent of butyllithium followed by reaction with one equivalent trans-[(L)₂NiX(Cl)].

We turn now to synthesis of the compounds (IV). Ligand is formed as described above for (III). Deprotonation, followed by reaction with trans-[(L)₂NiX(Cl)] gives (IV).

We turn now to the method embodiments of the invention herein.

The amount of compound (I) or compound (II) per mole of monomer ranges, for example, from 1 to 1×10⁻⁶ mmol per mole; i.e., this amount can provide catalytically effective amount.

The methylaluminoxane mentioned above is an activator for compounds (I)/(III).

Alternatives for the methylaluminoxane are reaction with a metal alkyl such as AlR₃ or ZnR₂ followed by reaction with (Ph₃C)(BAr₄), (PhNMe₂H) (BAr₄), Ar₃B or Ar₃Al, e.g., trialkylaluminum/fluorinated borate salts, e.g., i-Bu₃Al/Ph₃C⁺B(C₆F₅)₄⁻.

Activators for compounds (II)/(IV) are Lewis acids such as (1,5-cyclooctadiene)Ni, Ar₃B or Ar₃Al.

As used herein, the term “activator” means any compound that reacts with (I) or (II) to generate an active catalytic species in situ and the term “activated” means that (I) or (II) has been reacted with activator to convert M of (I) or (II) to cationic form and/or to cause rearrangement of (I) or (II) to a more active or selective form.

Amounts are given above exemplary for methylaluminoxane activating effective amount.

Reaction times typically range from 5 minutes to 1 hour.

Reaction temperatures can range, e.g., from 0 to 50° C.

A suitable solvent for the catalyst for the polymerizations/copolymerizations is toluene.

The invention is illustrated in the following working examples.

### Example 1

### Synthesis of (III) where M is Ti, X is Cl, R is CF₃, R³ is Ph—Compound 1a

This synthesis is set forth below. This compound is sometimes designated “CAT” hereinafter.

7-(2,2,2-Trifluoro-1-phenylimino-ethyl)-spiro[4,5]decan-6-one. A procedure similar to that used to make N-substituted β-enamino acid derivatives from 2-alkyl-2-oxazolines and N-arylimidoyl chloride as described in Fustero, S., et al., J. Org. Chem. 61, 8849-8859 (1996), was used. Thus, to a stirred solution of diisopropylamine (2.8 mL, 20 mmol) in THF (15 mL) at 0° C. was added n-butyllithium (1.6 M in hexanes, 12.5 mL, 20 mmol) dropwise. After being stirred for an additional 30 min. the solution was cooled to −78° C. and spiro[4,5]-decane-6-one (1.52 g, 10 mmol) in THF (15 ml) was added. The reaction mixture was stirred for 2 h, then lifted from the dry ice/acetone bath to warm to room temperature (RT) for 20 min. After cooling down to −78° C., a solution of the N-phenyl-2,2,2-trifluoroacetimidoyl chloride (2.07 g, 10 mmol) in THF (15 mL) was slowly added to the reaction mixture. When TLC analysis showed the disappearance of the starting material, the reaction was quenched by saturated ammonium chloride aqueous solution. The aqueous layer was extracted with CH₂Cl₂ (25 mL×3). The combined organic layers were washed with brine and dried over Na₂SO₄. After filtration, the solvents were removed under reduced pressure to furnish the crude product as brown oil. Purification by column chromatography over silica gel (5-7% (v/v) ethyl acetate/hexanes, R_{f}=0.5) afforded 1.3 g (41%) of pure product as a yellow oil. ¹H NMR (300 MHz): δ10.95 (s, 0.5H, OH/CH), 7.24 (m, 2H, ArH), 7.08 (t, J=7.5, 1H, ArH), 6.95 (d, J=8.1, 2H, ArH), 5.54 (brs, 0.1H, CH/OH), 2.70 (m, 2H, CH₂), 2.31-2.03 (m, 2H, CH₂), 1.86-1.80 (m, 4H, CH₂), 1.73-1.66 (m, 4H, CH₂), 1.51-1.39 (m, 2H, CH₂). ¹³C NMR (75 MHz): δ 208.5, 142.5, 129.2, 128.0, 124.1, 121.7, 119.7, 116.4, 56.2, 40.2, 38.6, 37.1, 35.2, 26.1, 21.7. ¹⁹F NMR (282 MHz): δ −68.3.

Ti complex 1a. The Ti complex 1a was synthesized following the procedure similar to that reported in literature to make phenoxyimine Ti complex with minor modifications. Thus, to a stirred solution of ligand 7-(2,2,2-trifluoro-1-phenylimino-ethyl)-spiro[4,5]decan-6-one (1.29 g, 3.98 mmol) in 20 mL of diethyl ether (Et₂O) at −78° C. was added n-BuLi (1.6 M in hexanes, 2.48 mL, 3.98 mmol) dropwise using a gas tight syringe. This solution was allowed to slowly return to room temperature and stirred for an additional half hour. The solution was then added dropwise via cannula to a solution of TiCl₄ (1.0 M in toluene, 2.0 mL, 2.0 mmol) in Et₂O (15 mL) at −78° C. The resulting deep red solution was allowed to warm naturally to room temperature and stirred for an additional 16 h. After removal of the solvent under vacuum, the residue was taken up in toluene and the precipitated LiCl was removed by filtration over a Celite plug. Removal of solvent in vacuo gave a deep red powder that was crystallized from a mixture of toluene/pentane to give the desired complex as a deep red crystalline solid (1.02 g, 67%). ¹H NMR (toluene-d₈, 500 MHz): δ 7.14 (d, J=7.0, 2H, ArH), 7.03 (t, J=7.8, 2H, ArH), 6.92 (t, J=7.2, 2H, ArH), 6.84 (t, J=7.2, 2H, Arh), 6.72 (d, J=7.0, 2H, ArH), 2.68 (m, 2H, CH₂), 2.48 (m, 2H, CH₂), 1.93 (m, 2H, CH₂), 1.81 (m, 2H, CH₂), 1.47-1.32 (m, 16H, CH₂), 1.11 (m, 2H, CH₂), 0.77 (m, 2H, CH₂). ¹³C NMR (toluene-d₈, 125 MHz): δ 187.4, 159.6 (q, J_{CF}=26.4), 150.2, 126.5, 122.7, 122.5, 120.1, 113.4, 51.3, 40.8, 40.1, 37.5, 27.7, 21.6. ¹⁹F NMR (toluene-d₈, 470 MHz): δ −60.0.

### Example II

### Synthesis of (III) where M is Ti, X is Cl, R is CF₃, R³ is 2,6-F₂Ph—Compound 1b

This synthesis is set forth below.

N-(2,6-Difluoro-phenyl)-2,2,2-trifluoro-acetimidoyl chloride. The procedure used to make N-phenyl analogue was followed. Thus, 2,6-difluoroaniline (5.17 mL, 6.20 g, 48 mmol) was reacted with trifluoroacetic acid (TFA, 3.08 mL, 4.56 g, 40 mmol) and carbon tetrachloride (CCl₄ 38.6 mL, 61.50 g, 400 mmol) in the presence of triphenylphosphine (Ph₃P, 31.47 g, 120 mmol) and triethylamine (Et₃N, 6.70 mL, 4.86 g, 48 mmol) under reflux condition for 6 h afforded 3.70 g (38%) of pure product as a colorless oil after vacuum distillation (54° C./240 mTorr). ¹H NMR (C₆D₆, 500 MHz): δ 6.35 (d, J=9.1, 2H, ArH-3,5), 6.33 (t, J=9.0, 1H, ArH-4). ¹³C NMR (C₆D₆, 125 MHz): δ 153.0 (dd, ¹J_{CF}=251.7, ³J_{CF}=4.2, ArC, ortho), 140.3 (N═C), 128.2, 122.4 (t, ³J_{CF}=16.0, ArC, para), 117.5 (q, ¹J_{CF}=278.0, CF₃), 112.3 (dd, ²J_{CF}=18.3, ⁴J_{CF}=4.6, ArC, meta). ¹⁹F NMR(C₆D₆, 470 MHz): δ −71.8, −121.0.

7-[1-(2,6-Difluoro-phenylimino)-2,2,2-trifluoro-ethyl]-spiro[4,5]decan-6-one. The procedure used to make N-phenyl analogue was followed. Thus, spiro[4,5]decan-6-one was reacted with diisopropylamine (2.8 mL, 2.02 g, 20 mmol) and n-BuLi (1.6 M in hexane, 12.5 mL, 20 mmol) in THF at −78° C., and then N-(2,6-difluoro-phenyl)-2,2,2-trifluoro-acetimidoyl chloride (2.44 g, 10 mmol) to afford 0.51 g (15%) of pure product as a yellow oil. ¹H NMR (300 MHz): δ 11.08 (s, 1H, OH/CH), 7.03 (m, 1H, ArH), 6.90 (m, 2H, ArH), 2.65 (brs, 2H, CH₂), 2.00-1.42 (m, 12H, CH₂). ¹³C NMR (75 MHz): δ 222.9, 221.9, 208.9, 125.1, 112.5, 111.8, 111.7, 111.5, 56.0, 38.8, 37.0, 27.1, 26.2, 21.9.

Ti complex 1b. The Ti complex 1b was synthesized following the procedure to make 1a. Thus, ligand 7-[1-(2,6-difluoro-phenylimino)-2,2,2-trifluoro-ethyl]-spiro[4,5]decan-6-one (0.57 g, 1.59 mmol) was reacted with n-BuLi (1.6 M in hexanes, 0.99 mL, 1.59 mmol) and then TiCl₄ (1.0 M in toluene, 0.8 mL, 0.8 mmol) to give a deep red powder that was crystallized from a mixture of toluene/pentane to give the desired complex as a deep red crystalline solid (0.15 g, 23%). ¹H NMR (toluene-d₈, 400 MHz): δ 6.55 (m, 4H, ArH), 6.40 (m, 2H, ArH), 2.80-0.80 (m, 28H, CH₂). ¹³C NMR (toluene-d₈, 100 MHz): δ 189.2, 127.8, 122.3, 119.4, 113.1, 112.5, 112.3, 111.6, 51.6, 40.9, 39.9, 37.4, 27.0, 21.4. ¹⁹F NMR (toluene-d₈, 376 MHz): δ −60.8, −113.2, −116.4. Anal Calcd for C₃₆H₃₄Cl₂F₁₀N₂O₂Ti: C, 51.76; H, 4.10; N, 3.35. Found: C, 51.59; H, 4.17; N, 3.10.

### Example III

### Synthesis of (III) where M is Ti, X is Cl, R is H and R³ is Ph—Compound 1c

This synthesis is set forth below.

6-Oxo-spiro[4,5]decane-7-carbaldehyde. The procedure similar to that reported in Lopez-Alvarada, P., et al., Eur. J. Org. Chem. 2002, 1702-1707 for formylation under basic conditions was followed. A solution of spiro[4,5]decan-6-one (2.70 g, 17.74 mmol) in dry toluene (40 mL) was added dropwise by a gas tight syringe at room temperature to a suspension of sodium methoxide (4.29 g, 75.44 mmol) in dry toluene (75 mL). The reaction mixture turned from white to pale yellow and was cooled to 0° C. After 20 min, ethyl formate (6.12 mL, 5.61 g, 75.73 mmol) was added dropwise by a gas tight syringe, and the reaction mixture was stirred at room temperature overnight. Diethyl ether (80 mL) was then added, and the suspension was washed with water (40 mL×2) and was titrated to pH=6 by 2N HCl (aq.). The ethereal solution was dried over Na₂SO₄, filtered, and concentrated under reduced pressure to yield 3.04 g (95%) product as a light yellow oil. ¹H NMR (300 MHz): δ 14.79 (d, J=3.3, 1H, OH/CH), 8.62 (d, J=3.3, 1H, CHO), 2.33 (t, J=6.2, 2H, CH₂), 2.12-1.42 (m, 12H, CH₂). ¹³C NMR (75 MHz): δ 191.4, 187.8, 108.1, 48.9, 39.3, 36.2, 26.5, 24.1, 20.7.

7-Phenyliminomethyl-spiro[4,5]decan-6-one. A 150 mL round bottom flask was charged with spiroaldehyde (1.00 g, 5.55 mmol), aniline (0.65 g, 6.93 mmol) and the mixture was stirred for ca 10 min to achieve total dissolution. p-Toluenesulfonic acid (p-TSA, 50 mg) and phosphorous pentoxide (P₂O₅, 50 mg) were added, and then the stirred mixture was heated to 110° C. (oil bath) for 2 h under nitrogen. After cooling down to room temperature, CH₂Cl₂ (180 mL) was added to dissolve the brown slurry and the solution was washed by water (60 mL×2), brine and then dried over Na₂SO₄. After filtration, the solvent was removed under reduced pressure. The product was purified by column chromatography over silica gel (10% (v/v) EtOAc/hexanes) to give 1.24 g (88%) of red oil. ¹H NMR (400 MHz): δ 11.89 (d, J=11.6, 1H, OH/CH), 7.23 (m, 2H, ArH-ortho), 7.10 (dt, J=12.0, 1.0, 1H, CHN), 6.98-6.93 (m, 3H, ArH-para+ArH-meta), 2.45-2.42 (m, 2H, CH₂), 2.04-2.00 (m, 2H, CH₂), 1.78-1.61 (m, 8H, CH₂), 1.47-1.41 (m, 2H, CH₂). ¹³C NMR (100 MHz): δ 206.0, 142.1, 140.6, 129.5, 122.6, 115.7, 104.6, 53.5, 39.3, 36.7, 28.9, 26.2, 21.4.

Ti complex 1c. The Ti complex 1c was synthesized following the procedure to make 1a. Thus, ligand 7-phenyliminomethyl-spiro[4,5]decan-6-one (1.24 g, 4.86 mmol) was reacted with n-BuLi (1.6 M in hexanes, 3.03 mL, 4.86 mmol) and then TiCl₄ (1.0 M in toluene, 2.43 mL, 2.43 mmol) to give a deep read powder (81 mg, 6%). ¹H NMR (toluene-d₈, 400 MHz): δ 7.02-6.84 (m, 12H, CHN+ArH), 2.39 (m, 2H, CH₂), 1.92 (m, 2H, CH₂), 1.80 (m, 4H, CH₂), 1.46-1.02 (m, 18H, CH₂), 0.70 (m, 2H, CH₂). ¹³CNMR (tonuene-d₈, 100 MHz): δ 182.2, 165.0, 154.6, 128.3, 125.8, 123.9, 112.3, 48.9, 40.1, 37.7, 36.9, 27.7, 26.6.

### Example IV

### Synthesis of (III) where M is Ti, X is Cl, R is H and R³ is 2,6-F₂Ph—Compound 1d

The synthesis of Compound 1d is set forth below.

7-[2,6-Difluoro-phenylimino)-methyl]-spiro[4,5]decan-6-one. The procedure to make N-phenyl analogue was followed. Thus, spiroaldehyde (0.72 g, 4.01 mmol) was reacted with 2,6-difluoroaniline (0.62 g, 4.81 mmol) in the presence of p-toluenesulfonic acid (40 mg) and P₂O₅ (50 mg) to afford 1.04 g (89%) of pure product as a yellow oil after column chromatography over silica gel (10% (v/v) EtOAc/hexanes). ¹H NMR (300 MHz): δ 11.88 (d, J=11.3, 1H, OH/CH), 7.30 (d, J=11.5, 1H, CHN), 6.87-6.79 (m, 3H, ArH), 2.42 (t, J=5.4, 2H, CH₂), 2.09-2.00 (m, 2H, CH₂), 1.79-1.60 (m, 8H, CH₂), 1.48-1.40 (m, 2H, CH₂). ¹³C NMR (75 MHz): δ 207.0, 153.8, (dd, J_{CF}=246.2, 5.8), 144.3 (t, J_{CF}=6.4), 121.6 (t, J_{CF}=9.7), 119.3 (t, J_{CF}=12.6), 112.3 (dd, J_{CF}=16.0, 7.7), 106.6, 54.1, 39.4, 36.8, 29.2, 26.4, 21.5. ¹⁹F NMR (282 MHz): δ −126.2.

Ti complex 1d. The Ti complex 1d was synthesized following the procedure to make 1a. Thus, ligand 7-[(2,6-difluoro-phenylimino)-methyl-spiro[4,5]decan-6-one (1.03 g, 3.54 mmol) was reacted with n-BuLi (1.6 M in hexanes, 2.21 mL, 3.54 mmol) and then TiCl₄ (1.0 M in toluene, 1.77 mL, 1.77 mmol) gave a deep red powder that was crystallized from toluene to give the desired complex as a deep red crystalline solid (0.83 g, 67%). ¹H NMR (toluene-d₈, 400 MHz): δ 7.07 (s, 2H, CHN), 6.55 (m, 4H, Arh), 6.38 (m, 2H, Arh), 2.20-0.80 (m, 28H, CH₂). ¹³C NMR (toluene-d₈, 100 MHz): δ 184.7, 169.7, 127.1, 112.2, 112.0, 111.9, 111.0, 49.4, 40.1, 37.7, 36.9, 27.7, 26.6. ¹⁹F NMR (toluene-d₈, 376 MHz): δ −116.1, −118.2. Anal Calcd for C₃₄H₃₆Cl₂F₄N₂O₂Ti: C, 58.39; H, 5.19; N, 4.01. Found: C, 58.45; H, 4.98; N, 3.79.

### Example V

### Synthesis of (III) where M is Ti, X is Cl, R is H, R³ is 3,5-F₂Ph—Compound 1e

The synthesis of Compound 1e is set forth below.

7-[3,5-Difluoro-phenylimino)-methyl]-spiro[4,5]decan-6-one. The procedure to make N-phenyl analogue was followed. Thus, spiroaldehyde (1.04 g, 5.77 mmol) was reacted with 3,5-difluoroaniline (0.91 g, 6.92 mmol) in the presence of p-toluenesulfonic acid (50 mg) and P₂O₅ (50 mg) to afford 1.35 g (81%) of pure product as a light yellow oil after column chromatography over silica gel (10% (v/v) EtOAc/hexanes). ¹H NMR (400 MHz): δ 11.72 (d, J=11.6, 1H, CH/OH), 6.87 (dt, J=11.6, 1.1, H, CHN), 6.39 (dd, J=9.0, 2.2, 2H, ArH-ortho), 6.30 (tt, J=8.9, 2.2, 1H, ArH-para), 2.82 (t, J=5.6, 2H, CH₂), 1.97-1.92 (m, 2H, CH₂), 1.72-1.56 (m, 8H, CH₂), 1.41-1.36 (m, 2H, CH₂). ¹³C NMR (100 MHz): δ 207.4, 165.4, 162.9, 143.5, 140.1, 106.7, 98.7, 97.5, 54.1, 39.4, 36.8, 29.2, 26.4, 21.5. ¹⁹F NMR (376 MHz): δ −108.9.

Ti complex 1e. The Ti complex 1e was synthesized following the procedure to make 1a. Thus, ligand 7-[(3,5-difluoro-phenylimino)-methyl]-spiro[4,5]decan-6-one (0.68 g, 2.33 mmol) was reacted with n-BuLi (1.6 M in hexanes, 1.46 mL, 2.33 mmol) and then TiCl₄ (1.0 M in toluene, 1.17 mL, 1.17 mmol) to give a deep red powder that was crystallized from toluene to give the desired complex as a deep red crystalline solid (0.088 g, 11%). ¹H NMR (toluene-d₈, 400 MHz): δ 6.74 (s, 2H, CHN), 6.46 (dd, J=8.7, 1.9, 4H, Arm), 6.34 (tt, J=9.0, 2.3, 2H, ArH), 2.36 (m, 2H, CH₂), 2.10-1.76 (m, 8H, CH₂), 1.49-1.13 (m, 16H, CH₂), 0.85 (m, 2H, CH₂). ¹³C NMR (toluene-d₈, 100 MHz): δ 184.2, 165.6, 164.2, 161.7, 156.3, 113.1, 107.9, 101.3, 49.4, 40.3, 37.6, 36.8, 27.8, 26.6. ¹⁹F NMR (toluene-d₈, 376 MHz): δ −109.51.

### Example VI

### Synthesis of (III) where M is Ti, X is Cl, R is H and R³ is F₅Ph—Compound 1f

The synthesis of Compound 1f is set forth below.

7-(Pentafluorophenylimino-methyl)-spiro[4,5]decan-6-one. The procedure to make N-phenyl analogue was followed. Thus, spiroaldehyde (0.66 g, 3.66 mmol) was reacted with 2,3,4,5,6-pentafluoroaniline (0.81 g, 4.42 mmol) in the presence of p-toluenesulfonic acid (40 mg) and P₂O₅ (50 mg) to afford 1.10 g (87%) of pure product as light yellow crystals after column chromatography over silica gel (10% (v/v) EtOAc/hexanes). ¹H NMR (500 MHz): δ 11.84 (d, J=11.0, 1H, CH/OH), 7.16 (d, J=11.3, 1H, CHN), 2.44 (m, 2H, CH₂), 2.06-2.00 (m, 2H, CH₂), 1.78-1.75 (m, 2H, CH₂), 1.73-1.66 (m, 6H, CH₂), 1.49-1.43 (m, 2H, CH₂). ¹³C NMR (125 MHz): δ 208.2, 142.3, (t, J=6.1), 140.0-139.4 (m), 138.1-136.9 (m), 135.2-134.9 (m), 117.7 (td, J=10.7, 4.1), 108.5, 54.5, 39.4, 36.7, 29.3, 26.4, 21.4. ¹⁹F NMR (376 MHz): δ −156.24 (d, J_{FF}=21.4), −163.07 (td, J_{FF}=21.4, 4.6), −166.08 (tt, J_{FF}=21.4, 4.6). Anal Calcd for C₁₇H₁₆F₅NO: C, 59.13; H, 4.67; N, 4.06. Found: C, 59.18; H, 4.60; N, 3.96.

Ti complex 1f. The Ti complex 1f was synthesized following the procedure to make 1a. Thus, ligand 7-[(pentafluorophenylimino)-methyl]-spiro[4,5]decan-6-one (1.08 g, 3.13 mmol) was reacted with n-BuLi (1.6 M in hexanes, 1.96 mL, 3.13 mmol) and then TiCl₄ (1.0 M in toluene, 1.57 mL, 1.57 mmol) to give a deep red powder that was crystallized from toluene to give the desired complex as a deep red crystalline solid (0.80 g, 63%). ¹H NMR (toluene-d₈, 400 MHz): δ 6.91 (s, 2H, CHN), 2.31-2.25 (m, 2H, CH₂), 2.07-1.95 (m, 2H, CH₂), 1.75-1.69 (m, 2H, CH₂), 1.59-1.56 (m, 2H, CH₂), 1.34-1.10 (m, 2H, CH₂), 0.88-0.83 (m, 2H, CH₂). ¹³C NMR (toluene-d₈, 100 MHz): δ 187.0, 170.2, 112.7, 49.8, 40.2, 37.4, 36.5, 27.6, 26.4, 26.1. ¹⁹F NMR (376 MHz): δ −145.6, −146.9, −158.9, −159.9, −162.6. Anal Calcd for C₃₄H₃₀Cl₂F₁₀N₂O₂Ti: C, 50.58; H, 3.75; N, 3.47. Found: C, 50.66; H, 3.52; N, 3.21.

### Example VII

### Synthesis of (III) where M is Zr, X is Cl, R is CF₃ and R³ is Ph—Compound 1g

Compound 1g is synthesized as follows: The ligand 7-(2,2,2-trifluoro-1-phenylimino-ethyl)-spiro[4,5]decane-6-one is synthesized as described in Example 1. A solution of the ligand in toluene is added to a solution of tetrakis(dimethylamino)zirconium in toluene solvent at room temperature, leading to an immediate color change from light yellow to orange, and then dark red. The resulting solution is stirred overnight to afford after solvent removal the complex L₂Zr(NMe₂)₂. Then the complex L₂Zr(NMe₂)₂ is dissolved in methylene chloride, and an excess (ca. 10 equivalent) of chlorotrimethylsilane is added. After stirring overnight at 22° C., the solvent is removed under vacuum. The dark red residue is triturated with pentane to afford a yellow solid.

### Example VIII

### Synthesis of (III) where M is Hf, X is Cl, R is CF₃ and R³ is Ph—Compound 1h

Compound 1h is synthesized as follows: The ligand 7-(2,2,2-trifluoro-1-phenylimino-ethyl)-spiro[4,5]decane-6-one is synthesized as described in Example I. A solution of the ligand in toluene is added to a solution of tetrakis(dimethylamino)hafnium in toluene solvent at room temperature, leading to an immediate color change. The resulting solution is stirred overnight to afford after solvent removal the complex L₂Hf(NMe₂)₂. Then the complex L₂Hf(NMe₂)₂ is dissolved in methylene chloride, and an excess (ca. 10 equivalent) of chlorotrimethylsilane is added. After stirring overnight at 22° C., the solvent is removed under vacuum. The residue is triturated with pentane to afford compound 1h as a solid.

### Example 1X

### Synthesis of (IV) where L is Ph₃P, X is Ph, M is Ni, R is CF₃ and R³ is Ph—Compound 1i

Compound 1i is synthesized as follows: The ligand 7-(2,2,2-trifluoro-1-phenylimino-ethyl)-spiro[4,5]decane-6-one is synthesized as set forth in Example I. The ligand is deprotonated in toluene solvent with one equivalent n-butyllithium at −78° C. Then one equivalent of trans-[(Ph₃P)₂NiPh(Cl)] in toluene is added. After stirring overnight at 22° C., the suspension is filtered to remove LiCl. Upon concentration of the toluene, crystals of Compound 1i are grown and isolated after decanting the mother liquor.

### Example X

### Polymerization of Ethylene

Polymerizations of ethylene were carried out with 1a, 1b, 1c, 1d, 1e and 1f upon activation with methylaluminoxane (MAO). The polymerization conditions are as follows: 10 psi ethylene, 0.01 mmol catalyst, 80 ml toluene, 1.5 mmol MAO. Results obtained are set forth in said Table 1 below.

TABLE 1
Polymerization of Ethylene with 1a-1f/PMAO

| | | | Temp. | Time | Yield | Activity | Mₙ | | Mₙ (Calcd) | Tₘ |
|---|---|---|---|---|---|---|---|---|---|---|
| Catalyst | R | Ar (R³) | (° C.) | (min) | (mg) | (mol E/(mol Ti h)) | (g/mol) | PDI | (g/mol) | (° C.) |
| 1a | CF₃ | Ph | 0 | 10 | 850 | 18 200 | 104 200 | 1.12 | 85 000 | 134.8 |
| 1a | CF₃ | Ph | 25 | 10 | 794 | 17 000 | 119 500 | 1.12 | 79 400 | 134.2 |
| 1a | CF₃ | Ph | 50 | 10 | 410 | 8 780 | 89 290 | 1.54 | 41 000 | 133.1 |
| 1b | CF₃ | 2,6-F₂Ph | 0 | 10 | 620 | 13 300 | 66 600 | 1.11 | 62 000 | 134.0 |
| 1b | CF₃ | 2,6-F₂Ph | 25 | 10 | 762 | 16 350 | 77 640 | 1.10 | 76 200 | 134.0 |
| 1b | CF₃ | 2,6-F₂Ph | 50 | 10 | 454 | 9 740 | 66 240 | 1.22 | 45 400 | 134.0 |
| 1c | H | Ph | 0 | 20 | 158 | 1 690 | 11 500 | 1.10 | 15 800 | 133.7 |
| 1c | H | Ph | 25 | 10 | 80 | 1 710 | 8 940 | 1.05 | 8 000 | 130.8 |
| 1c | H | Ph | 50 | 10 | 200 | 2 140 | 21 940 | 1.14 | 20 000 | 132.8 |
| 1d | H | 2,6-F₂Ph | 0 | 10 | 8 | 200 | N/D | | | |
| 1d | H | 2,6-F₂Ph | 25 | 10 | 5 | 125 | N/D | | | |
| 1d | H | 2,6-F₂Ph | 50 | 10 | 36 | 900 | 2 090 | 1.04 | 3 600 | 130.6 |
| 1e | H | 3,5-F₂Ph | 0 | 10 | 255 | 5 460 | 29 700 | 1.10 | 25 500 | 133.3 |
| 1e | H | 3,5-F₂Ph | 25 | 10 | 405 | 8 660 | 35 710 | 1.10 | 40 500 | 133.2 |
| 1e | H | 3,5-F₂Ph | 50 | 10 | 548 | 11 720 | 36 870 | 1.44 | 54 800 | 132.9 |
| 1f | H | F₅Ph | 0 | 10 | 49 | 1 100 | 5 000 | 1.05 | 4 900 | 130.4 |
| 1f | H | F₅Ph | 25 | 10 | 67 | 1 510 | 6 300 | 1.08 | 6 700 | 130.3 |
| 1f | H | F₅Ph | 50 | 10 | 133 | 2 990 | 8 740 | 1.36 | 13 300 | 131.1 |

Conditions: 0.01 mmol catalyst; 80 mL toluene; 1.5 mmol PMAO, [Al]:[Ti] = 150, 10 psi ethylene.

When activated with MAO, these complexes are active for the polymerization of ethylene at 0 to 50° C. (Table 1). The activity of compound 1a was found to be higher than that of the analogous phenoxyketimine catalyst.

As shown in Table 1, living polymerization was obtained with all the complexes in the range of 0 to 25° C. including the CF₃ substituted ketimine catalysts 1a and 1b.

The polymerization results for Compound 1b and 1e with various reaction times are shown in Tables 2 and 3 below, respectively.

TABLE 2
Polymerization of Ethylene with 1b/PMAO

| Cat. | Time | Yield | Mₙ | Mₙ | |
|---|---|---|---|---|---|
| (mg) | (min.) | (mg) | (Calcd) | (PE Vis) | PDI |
| 12.6 | 1 | 87 | 5750 | 6530 | 1.08 |
| 12.6 | 2 | 188 | 12450 | 13270 | 1.09 |
| 12.6 | 4 | 386 | 25560 | 26940 | 1.09 |
| 12.6 | 6 | 579 | 38340 | 39060 | 1.11 |
| 12.6 | 12 | 958 | 63440 | 61650 | 1.12 |

TABLE 3
Polymerization of Ethylene with 1e/PMAO

| Cat. | Time | Yield | Mₙ | Mₙ | |
|---|---|---|---|---|---|
| (mg) | (min.) | (mg) | (Calcd) | (PE Vis) | PDI |
| 4.4 | 2 | 36 | 5700 | 5704 | 1.07 |
| 4.4 | 4 | 72 | 11540 | 12863 | 1.08 |
| 4.4 | 6 | 139 | 22360 | 20047 | 1.05 |
| 4.4 | 8 | 144 | 23145 | 26038 | 1.07 |
| 4.4 | 10 | 165 | 26495 | 32061 | 1.06 |
| 4.4 | 12 | 212 | 34044 | 37137 | 1.07 |
| 4.4 | 20 | 323 | 51772 | 60630 | 1.07 |

All the polyethylene products exhibited melting points in the range of 131 to 135° C. The ¹³C NMR analysis indicates that these PE samples have linear structures with non-detectable branching.

### Example XI

### Polymerization of Propylene

Polymerization of propylene was carried out with 1a, 1b, 1d, 1e and 1f. When R³ in the ligand was unsubstituted phenyl (ligand (1c)), the catalyst was not active for propylene polymerization. Conditions and results are shown in Table 4 below.

TABLE 4
Polymerization of Propylene with 1a-1f/PMAO

| | | | | Yield | Activity | Mₙ (GPC) | | |
|---|---|---|---|---|---|---|---|---|
| Catalyst | R | Ar | [Al]/[Ti] | (mg) | (Kg PP/(mol Ti h)) | (g/mol) | PDI | Tacticity |
| 1a | CF₃ | Ph | 300 | 248 | 2.07 | 963,000 | 1.59 | atactic |
| 1b | CF₃ | 2,6-F₂Ph | 300 | 75^{a} | 1.88 | 218,900 | 3.52 | atactic |
| 1c | H | Ph | 150 | N/A^{b} | | | | |
| 1d | H | 2,6-F₂Ph | 300 | 120 | 1.00 | 119,700 | 2.13 | atactic |
| 1e | H | 3,5-F₂Ph | 150 | 165 | 1.38 | 3,700 | 1.25 | syndio-enriched |
| 1f | H | F₅Ph | 300 | 19 | 0.16 | 585,700 | 1.43 | iso-enriched |

Conditions: 0.02 mmol catalyst (Ti complex), 0° C., 6 h, 80 mL toluene, 30 psi propylene.
^{a}0.01 mmol cat., 4 hours.
^{B}Not active.

Fluorine atoms at the ortho position of N-aryl of R³ (1b and 1d) led to production of atactic polypropylene while fluorine atoms at meta positions of N-aryl of R³ (1e) led to syndio-enriched polypropylene ([rrr]=0.40). Pentafluoro substituted N-aryl catalyst (1f) generated iso-enriched polypropylene ([mmmm]=0.20).

Polymerization of propylene was carried out with 1g by using two different activators. When methylaluminoxane (MAO) was used, atactic polypropylene was produced (Turnover Frequency (TOF): 30.4 mol P/mol Zr.h; Mₙ=508 600, PDI=1.69). When i-Bu₃Al/Ph₃C⁺B(C₆F₅)₄⁻ was used as activator, iso-enriched polypropylene was generated (TOF=129.8 mol P/mol Zr.h; bimodal GPC trace, PDI=2.86).

### Example XII

### Polymerization of Cyclopentene

Polymerization is conducted in a 3-ounce Lab-Crest™ pressure reaction vessel equipped with a magnetic stir bar. The reactor is first conditioned under dynamic vacuum and high temperature and then charged with a 3 mmol of PMAO in toluene and 5 mL of cyclopentene under nitrogen. Then 20 mmol of CAT is dissolved in toluene (3 mL) at room temperature under nitrogen. The solution is then added to the reactor using a syringe. Finally, the reactor is adjusted at 70° C. After 16 h, the reactor contents are poured into methanol/HCl and polymer is isolated by filtration.

### Example XIII

### Polymerization of Norbornene

Polymerization is conducted in a 3-ounce Lab-Crest™ pressure reaction vessel equipped with a magnetic stir bar. The reactor is under dynamic vacuum and high temperature and then charged with a 3 mmol of PMAO in toluene and 5 mL of norbornene under nitrogen. Then 20 mmol of CAT is dissolved in toluene (3 mL) at room temperature under nitrogen. The solution is then added to the reactor using a syringe. Finally, the reactor is adjusted at 70° C. After 16 h, the reactor contents are poured into methanol/HCl and polymer is isolated by filtration.

### Example XIV

### Cyclopentene/Ethylene Copolymerization

Polymerization is conducted in a 3-ounce Lab-Crest™ pressure reaction vessel equipped with a magnetic stir bar. In a typical polymerization experiment, the reactor is charged with 6 mmol of PMAO in toluene under nitrogen. Then 13.2 mL of cyclopentene is introduced. CAT is dissolved in toluene (5 mL) at room temperature under nitrogen. The solution is then added to the reactor via syringe, such that the fixed [Al]/[M] ratio is 150. Finally, the reactor is pressurized with ethylene gas and adjusted to the desired pressure and temperature. After the desired period of time, the reactor is vented. The polymer is precipitated from methanol/HCl, filtered, and then dried in vacuo to constant weight.

### Example XV

### Propylene/Ethylene Copolymerization

A 6-ounce Lab-Crest™ pressure reaction vessel equipped with a magnetic stir bar is first conditioned under dynamic vacuum and high temperature and then charged with PMAO (0.31 g, 5.3 mmol) and toluene (100 mL). The reactor is then equilibrated at 0° C. At this point, the reactor atmosphere is exchanged with propylene three times, and then the solution is saturated under propylene pressure (30 psi). An overpressure of ethylene (33 psi) is then introduced to the reactor and a toluene solution (4 mL) of CAT (0.01 mmol, [Al]/[M]=500), is added via syringe. After 1 h, the reactor is vented and the polymer is precipitated in methanol/HCl, filtered, washed with methanol, and then dried in vacuo to constant weight.

### Variations

The foregoing description of the invention has been presented describing certain operable and preferred embodiments. It is not intended that the invention should be so limited since variations and modifications thereof will be obvious to those skilled in the art, all of which are within the spirit and scope of the invention.

What is claimed is:

1. Compound having the structure: 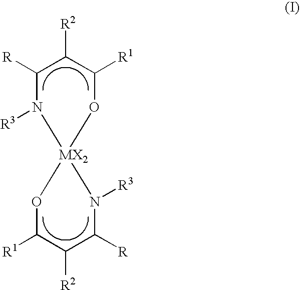
where M is selected from the group consisting of titanium, zirconium and hafnium; where X is selected from the group consisting of halogens, C₁-C₂₀ hydrocarbons, C₁-C₂₀ alkoxides and C₁-C₂₀ amides; where R is selected from the group consisting of hydrogen, C₁-C₂₀ hydrocarbons, C₁-C₂₀ fluorocarbons and C₃-C₂₀ heterocycles; where R¹ is selected from the group consisting of C₂-C₂₀ hydrocarbons bound by a tetrahedral carbon atom, i.e., where carbon alpha to carbonyl carbon, i.e., the carbon bonded to oxygen of ketoimine moiety, of ketoimine moiety is a tetrahedral carbon; R² is selected from the group consisting of hydrogen, C₁-C₂₀ hydrocarbons, C₁-C₂₀ fluorocarbons and C₃-C₂₀ heterocycles; R³ is selected from the group consisting of C₁-C₂₀ hydrocarbons, C₁-C₂₀ fluorocarbons and C₃-C₂₀ heterocycles; where two or more of R, R¹, R² and R³ can be bonded together to form a ring; or having the structure: 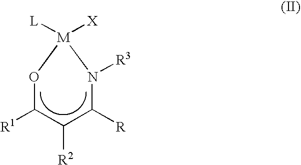
where M is selected from the group consisting of nickel and palladium, L is a neutral two electron donor (i.e., an uncharged group which fulfills the function of filling the coordination valance of M, e.g., an ether, phosphine or nitrile group), X, R, R¹, R² and R³ are defined as above and where two or more of R, R¹, R² and R³ can be bonded together to form a ring.

2. The compound of claim 1 having the structure (I) where M is titanium.

3. The compound of claim 1 where R¹ and R² are bonded together to form spiro[4,5]decan-6-onato.

4. The compound of claim 3 where M is titanium or zirconium, X is selected from the group consisting of halogens and C₁-C₂₀ hydrocarbons, and R³ is selected from the group consisting of phenyl and fluorinated aryl.

5. The compound of claim 4 where X is Cl and R is hydrogen or CF₃.

6. The compound of claim 4 which contains at least one fluorine atom.

7. The compound of claim 1 having the structure (II) where R¹ and R² are bonded together to form spiro[4,5]decane-6-onato.

8. The compound of claim 7 where X is Cl, R is hydrogen or CF₃ and R³ is selected from the group consisting of phenyl and fluorinated phenyl.

9. A method for the polymerization of ethylene, comprising the step of polymerizing ethylene in the presence of a catalytically effective amount of activated compound of claim 1, thereby producing polyethylene of Mₙ in the range of 1,000 to 3,000,000 g/mol and PDI in the range of 1 to 3.

10. A method for the polymerization of ethylene, comprising the step of polymerizing ethylene in the presence of a catalytically effective amount of compound of claim 5 activated by an activating effective amount of methylaluminoxane, thereby to produce polyethylene of Mₙ in the range of 1,000 to 3,000,000 g/mol and PDI in the range of 1 to 3.

11. A method for polymerization of a C₃-C₁₀ alpha olefin, comprising the step of polymerizing the C₃-C₁₀ alpha-olefin in the presence of a catalytically effective amount of activated compound of claim 1, thereby producing poly(C₃-C₁₀ alpha olefin) of Mₙ in the range of 1,000 to 3,000,000 g/mol and PDI in the range of 1 to 3.

12. The method of claim 11 where said compound contains at least one fluorine atom.

13. A method for the polymerization of a C₃-C₁₀ alpha olefin, such method comprising the step of polymerizing the C₃-C₁₀ alpha-olefin in the presence of a catalytically effective amount of the compound of claim 6 activated by an activating effective amount of methylaluminoxane, thereby to produce poly(C₃-C₁₀ alpha olefin) of Mₙ in the range of 1,000 to 3,000,000 g/mol and PDI in the range of 1 to 3.

14. A method for the polymerization of a C₄-C₁₀ cyclic alkene, comprising the step of polymerizing C₄-C₁₀ cyclic alkene in the presence of a catalytically effective amount of activated compound of claim 1, thereby to produce poly(C₄-C₁₀ cyclic alkene) having Mₙ ranging from 1,000 to 3,000,000 g/mol.

15. A method for polymerization of a C₄-C₁₀ cyclic alkene comprising the step of polymerizing C₄-C₁₀ cyclic alkene in the presence of a catalytically effective amount of compound of claim 5 activated by an activating effective amount of methylaluminoxane, thereby to produce poly(C₄-C₁₀ cyclic alkene) having Mₙ ranging from 1,000 to 3,000,000 g/mol.

16. A method for copolymerizing ethylene and a comonomer selected from the group consisting of C₃-C₁₀ alpha olefin, styrene, C₃-C₁₀-diene, C₂-C₁₀ alkenyl chloride and C₄-C₁₀ cyclic alkene, comprising the step of copolymerizing ethylene and said comonomer in a mole ratio of ethylene to comonomer ranging from 1:99 to 99:1, in the presence of a catalytically effective amount of activated compound of claim 1, thereby to produce copolymer of ethylene and said comonomer having Mₙ ranging from 1,000 to 3,000,000 g/mol.

17. The method of claim 16 where when the comonomer comprises C₃-C₁₀ alpha olefin, said compound contains at least one fluorine atom.

18. A method for copolymerizing ethylene and a comonomer selected from the group consisting of C₃-C₁₀ alpha olefin, styrene, C₃-C₁₀ diene, C₂-C₁₀ alkenyl halide and C₄-C₁₀ cyclic alkene, comprising the step of copolymerizing ethylene and said comonomer in a mole ratio of ethylene to comonomer ranging from 1:99 to 99:1, in the presence of a catalytically effective amount of compound of claim 5 activated by an activating effective amount of methylaluminoxane, thereby to produce copolymer of ethylene and said commoner having Mₙ ranging from 1,000 to 3,000,000 g/mol.

19. The method of claim 18 where when the comonomer comprises C₃-C₁₀ alpha olefin, said compound contains at least one fluorine atom.
